(19) United States
(12) Patent Application Publication
(10) Pub. No.: US 2025/0032958 A1
(43) Pub. Date: Jan. 30, 2025

(54) Apparatus for Separating a Gas from a Multiphase Material

(71) Applicant: Coalbed Innovations Pty Ltd, Hornsby (AU)

(72) Inventor: Duncan MacDonald, Hornsby (AU)

(21) Appl. No.: 18/592,747

(22) Filed: Mar. 1, 2024

(30) Foreign Application Priority Data
Jul. 26, 2023 (AU) 2023902380

(51) Int. Cl. B01D 19/00

(52) U.S. Cl. CPC B01D 19/0063; B01D 19/0057

(57) ABSTRACT

Apparatus for separating a gaseous phase from a multiphase feed material of solids, liquids and gases are described, the apparatus comprising: —a separation chamber arranged to receive a flow of the feed material thereinto via an inlet; —a first outlet conduit, arranged in use to convey an exit flow of gaseous material which becomes separated from the feed material when in the chamber; and—a second outlet conduit, arranged in use to convey an exit flow of the remainder of the feed material following separation of the gaseous material; —a differential pressure measurement arrangement is associated with the first outlet conduit and is arranged to measure the difference between the pressures of the gaseous material inside the conduit at two spaced-apart locations along the conduit, to thereby enable a measurement of the flowrate of the gaseous material through the conduit.

### CROSS REFERENCE TO RELATED APPLICATION

This application is a U.S. application claiming priority to Australian Patent Application No. 2023902380, filed Jul. 26, 2023, the entire disclosure of which is incorporated herein by reference in its entirety.

### TECHNICAL FIELD

This disclosure relates generally to the separation of gas-solid-liquid slurries that are produced during drilling and exploration for coal mining and more particularly, but not exclusively, to the removal of coal seam gases from slurries produced by such mining systems. The disclosure is also concerned with the design of a new apparatus to safely measure the flowrate at which formation fluids such gases and water are expected to be emitted from such mining activities, using an improved method of flowrate measurement.

### BACKGROUND OF THE DISCLOSURE ART

When doing exploratory drilling for assessing a deposit of underground coal, as well as when undertaking the work of mining production to recover coal, inevitably solid-liquid slurries will be generated. These slurries include cut or drilled rock and particulate carbonaceous minerals of all sizes which becomes mixed with drilling fluids and groundwater extracted from the local strata.

During the exploratory drilling and mining of coal deposits, a well-known hazard is the concomitant removal of coal seam gases (CSG) which are released by such mining operations. These gases include methane and carbon dioxide, along with other hydrocarbon and volatile organic compounds, which are initially absorbed in the coal matrix.

CSG is often highly flammable and presents a safety risk to life as well as to any mining equipment if these gases encounter a spark or an electrical discharge from industrial machinery, such as pumps or drilling tools being used underground. It is desirable to remove CSG from slurries.

During coal exploratory drilling it is useful to have an assessment of the expected flowrate of the release of gases from an ore deposit, and it is also useful to understand how much absorbed CSG is present in a multiphase slurry of particulate solids which is suspended in water, as an indication of how much CSG will be released during pre-drainage drilling and the remainder that may be released during mining or subsequent ore processing. Also, in the production of CSG by gas drainage from an underground coal seam reservoir, the likely rate of CSG production can be forecast by analysis of the rates obtained during exploration drilling. This enables more accurate planning of pre-drainage drilling. Likewise, the gas rates obtained during drilling may be used to forecast the injectivity of waste gasses back into other coal seams. The rate of water flow is important understand the connectivity to local groundwater. By monitoring the differences between water or drilling mud pumped into a hole and the rate of water flowing out, connections to groundwater and flow potentials can be obtained.

There remains a need to provide improved apparatus for assessing the levels of CSG or other gases and groundwater which are being released in exploratory or mining operations.

### SUMMARY

In a first aspect, embodiments are provided of an apparatus for separating a gaseous phase from a multiphase feed material of solids, liquids and gases, the apparatus comprising Apparatus for separating a gaseous phase from a multiphase feed material of solids, liquids and gases, the apparatus comprising:
a separation chamber arranged to receive a flow of the feed material thereinto via an inlet;
a first outlet conduit, arranged in use to convey an exit flow of gaseous material which becomes separated from the feed material when in the chamber; and
a second outlet conduit, arranged in use to convey an exit flow of the remainder of the feed material following separation of the gaseous material;
a differential pressure measurement arrangement is associated with the first outlet conduit and is arranged to measure the difference between the pressures of the gaseous material inside the conduit at two spaced-apart locations along the conduit, to thereby enable a measurement of the flowrate of the gaseous material through the conduit.

The differential pressure measurement arrangement may include a differential pressure sensor.

A pressure measurement arrangement may also be associated with the second outlet conduit and is arranged to measure the pressure of the material inside the conduit at two spaced-apart positions along the conduit, to thereby enable a measurement of the flowrate of the material through the conduit.

The separator may include a further pressure measurement device which is arranged to measure the pressure of material inside the separation chamber.

The separation chamber may comprise a cyclonic separator having a central axis, and which further comprises:
that the inlet for delivering the flow of feed material is arranged in a lateral direction to the central axis;
the separation chamber is of a generally conical internal shape extending in the direction of the central axis, with a decreasing distance between its internal side wall and the central axis when moving away from the inlet;
the first outlet has an overflow discharge located at an upper in use end wall coaxial with the central axis; and region; and
the second outlet is an underflow discharge arranged at a lower in use end region coaxial with the central axis.

At least one of the outlet conduits may be arranged in a convoluted configuration.

The convoluted conduit may comprise a plurality of straight pipe sections which are interspersed with angled pipe sections.

The angled pipe sections may subtend a 90-degree angle bend.

The pipe sections comprising each respective outlet conduit may be of substantially equal internal bore diameter.

The second outlet conduit may be spaced away from the separator.

Aspects, features, and advantages of this disclosure will become apparent from the following detailed description when taken in conjunction with the accompanying drawings, which are a part of this disclosure and which illustrate, by way of example, principles of any inventions disclosed.

### BRIEF DESCRIPTION OF THE DRAWINGS

The accompanying drawings facilitate an understanding of the various embodiments which will be described:

FIG. 1 is a front, perspective, schematic view of an apparatus for separating a gaseous phase from a multiphase feed material, in accordance with an embodiment of the present disclosure;

FIG. 2 is a front view of the apparatus of FIG. 1 with upper and lower inspection covers removed;

FIG. 3 is a schematic, perspective view of the apparatus of FIG. 1 with upper and lower front protective covers removed;

FIG. 4 is a side cross sectional view of the apparatus of FIG. 1;

FIG. 5 is a cross section through the plane B-B of FIG. 2;

FIG. 6 shows the transmitter mounting of the apparatus of FIG. 1 with pressure sensors attached;

FIG. 7 is an exploded, front, perspective view of the apparatus of FIG. 1;

FIGS. 8 and 9 depict examples of types of pressure sensors suitable for use in the apparatus of FIG. 1;

FIG. 10 shows plots of measured differential pressures for various flow rates of gases obtained during a calibration phase;

FIG. 11 is a schematic view of an alternative embodiment of separation apparatus; and

FIG. 12 shows an alternative embodiment of apparatus.

### DETAILED DESCRIPTION

This disclosure relates to the features of an apparatus for separating gases from multiphase mixtures comprising gas-solid-liquid slurries, being mixtures in which gases can be both adsorbed onto particle surfaces, as well as being absorbed into liquids such as groundwater.

The disclosure also relates to the features of the apparatus which can be used to make a measurement of the flowrate of those separated gases, particularly where those gases are flammable in nature in a manner, without introducing any sensor or other occlusion into the flow path of the gases and with a very low risk of a spark being generated in use, damage to the sensing system or blockage occurring. The design also avoids the use of flowpath restrictions such as orifice plates to create a measurable differential pressure as these create the risk of plugging of the flow line that leads to hazardous gas build-ups. The convoluted pipework flow measurement enables reliability in an environment where the device is typically relocated by mechanical dragging, dropping and rolling—an environment unsuited to the typical implementation of process instrumentation.

The disclosure therefore offers a method for processing a multiphase mixture and safely measuring the flowrate of any gases and liquids which are released during such an operation. The apparatus therefore has wide applicability compared with known techniques in fields such as coal mining, coal exploration drilling and the displacement production of CSG.

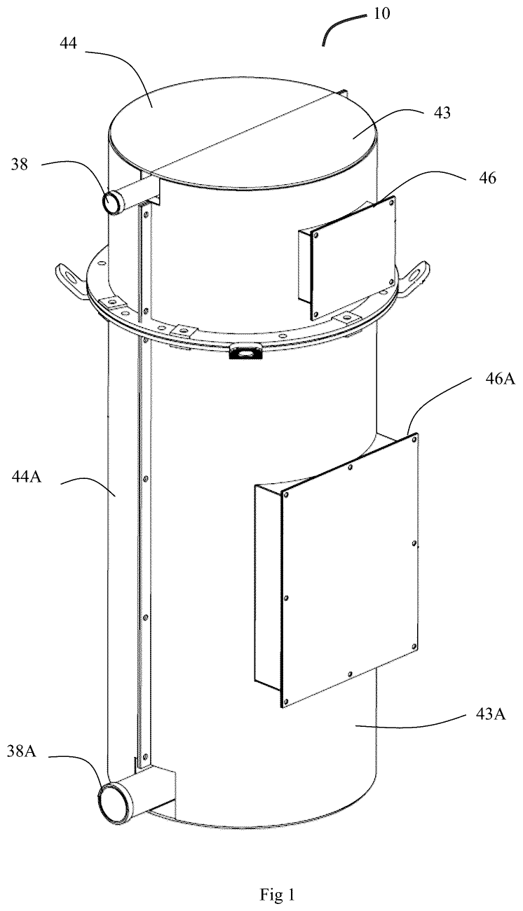

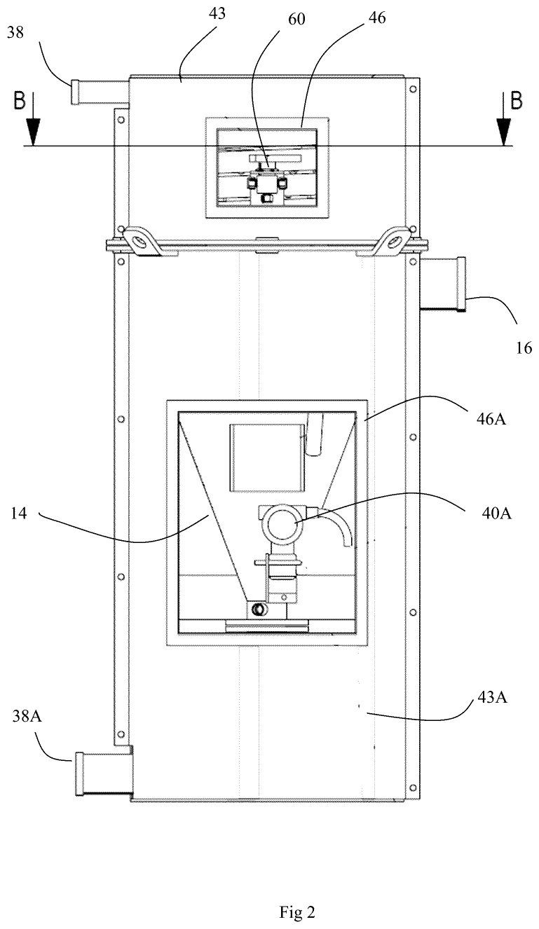

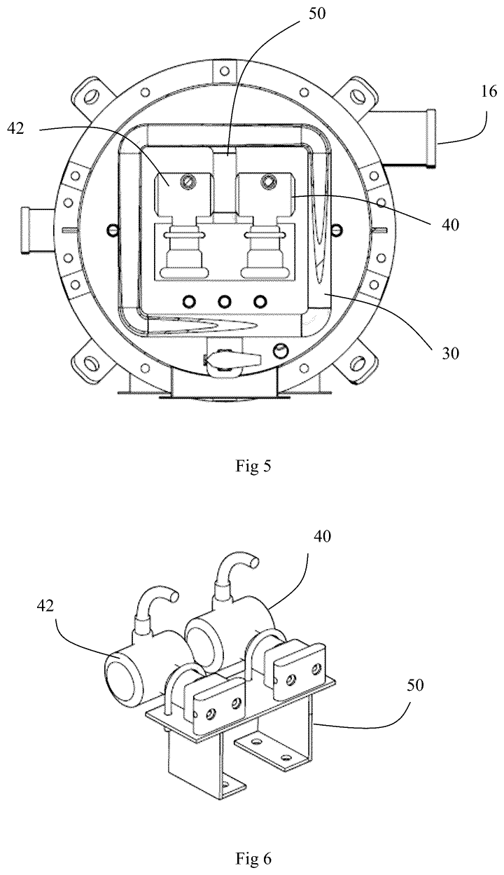

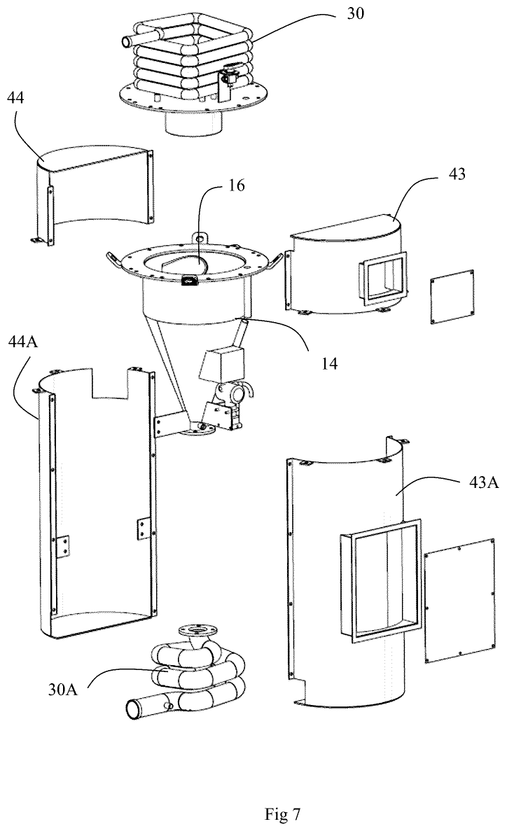

Referring to FIGS. 1 to 7, a cyclonic separator (10) is shown, comprising a separation chamber (14), a feed inlet conduit (16) leading into a feed chamber (18) which has an inner side wall (20), an upper end wall (22) at one end of said inner side wall (20), and an open end at the other end of said inner side wall (20), the open end (21) being of a circular cross-section with a central axis (X). The feed inlet conduit (16) is depicted in the form of a tubular port which is located adjacent the upper end wall (22) for delivering feed material to be separated into the feed chamber (18), the inlet conduit (16) arranged in a lateral direction to the central axis (X) as is known in the art.

An overflow outlet (24) of the feed chamber (18) is arranged in the upper end wall (22) to be coaxial with the central axis (X). A vortex finder (26) extends into the feed chamber (18) in the direction of the central axis (X). The vortex finder is circular in horizontal cross-section and cylindrical in shape, in use its inlet end being positioned in the feed chamber (18), its outlet end defining an overflow discharge of the cyclonic separator (10).

The separator 10 includes a first outlet in the form of first convoluted conduit (30). In use a flow of gaseous material flows upwardly out of the feed chamber (18) and/or the separation chamber (14) via the vortex finder (26), and into the convoluted conduit (30).

In the embodiment shown, the first convoluted conduit (30) is in in the form of a stacked spiral coil of metal pipe arranged to be in a generally square shape, when viewed in plan. Each straight length of pipe (32) is joined to the next by a 90 angle-degree pipe bend (34), and the stacked pipe coil shown comprises a total of 24 of these pipe bends (34). Typically, the pipes themselves comprise <45 mm ID steel gas lines, in which a differential pressure of around 5.5 kPa is generated with and a gaseous material flowrate of around 2000 m3/day. In other embodiments, a different shape and configuration of a stacked spiral coil of pipes can be interchanged with the one shown in the drawings, and, in addition, the diameter of the pipes can be altered, for example, to achieve a greater flowrate of the gas material exiting the cyclonic separator (10).

The first convoluted conduit (30) shown in the drawings is mounted to a support platform (36) located at the surface of the upper end wall (22) of the cyclonic separator (10). The convoluted conduit (30) has its pipework arranged with an alignment to cause any condensed vapour or liquid to drain back out of the conduit (30) under gravity. The first convoluted conduit terminates at upper outlet opening (38) via which gaseous material is passed to a further process stage (not shown).

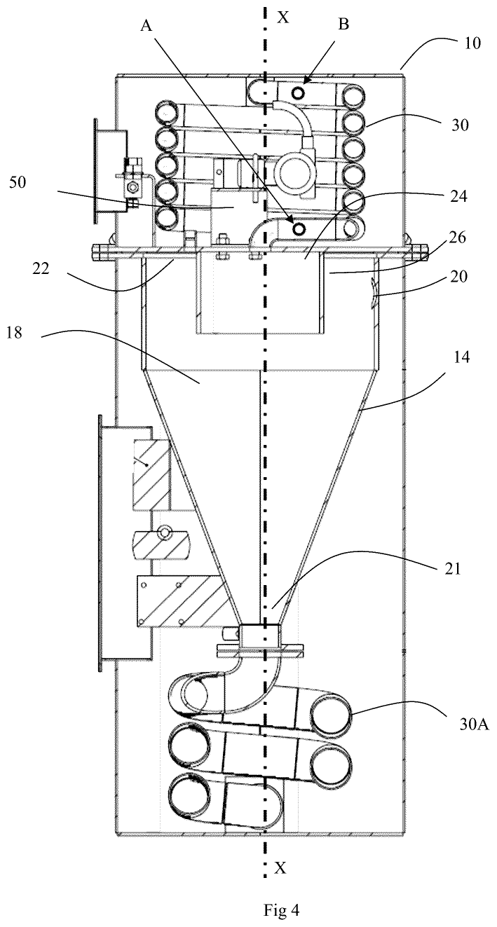

As best seen in FIG. 4, a pressure measurement arrangement in the form of a differential pressure sensor (40) is associated with the conduit (30) and is plumbed to the conduit (30) by smaller diameter pressure hoses (not shown) which attach to apertures in the conduit (30) at two spaced-apart locations (A) and (B). Location (A) is located on the conduit 30 near to the position where the convoluted conduit (30) is joined to an uppermost in use end of the feed chamber (18). Location (B) is located on the conduit at a location near to outlet opening (38) of the conduit (30).

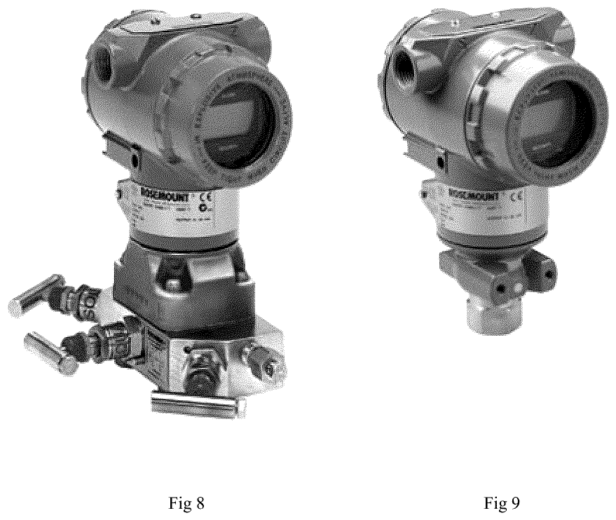

The interior region of the convoluted conduit (30) defines a volume of generally square plan cross-section, within which a mounting bracket (50) is positioned and fastened atop the support platform (36). The pressure sensor (40) is mounted to the bracket (50) and may be an Emerson 3051 wireless differential enabled type pressure sensor similar to the one shown in FIG. 8. The pressure sensor (40) is powered by and transmits its measurement data to a separately located control system (not shown) which receives and processes the data.

In use, the separation treatment of the multiphase feed material using the cyclonic separator (10) induces a flow of gas to become separated from the solid-liquid mixture in which it is initially mixed, and then to move out of the chamber by flowing out through the convoluted conduit (30), wherein, by that stage, said gas is substantially free of liquid and solid particulate matter.

Such an arrangement for detection of the differential pressure between two spaced apart locations and can be calibrated so that the differential pressure reading enables an operator or control system to deduce the flow rate of gaseous material within the conduit. The introduction of a plurality of pipe bends to provide a convoluted flow path of adjoined conduits lengths aims to produces a much more substantial fluid pressure drop over a relatively short length of conduit, because of the increased frictional losses induced in the internal fluid flow pattern within the conduit. By creating a stacked spiral coil of structure of conduits, the inventor has also created a fluid flow environment within the conduits which achieves a substantial pressure drop in a very compact physical area, without an internal flow path restriction, enabling the conduit(s) as well as the pressure measurement apparatus to be contained within a simple cylindrical protective housing. The conduit (30) gives rise to a significant pressure drop over the length of the convoluted conduit, thereby enabling a high-resolution calculation of the flowrate of the gases and vapours passing therethrough with more precision.

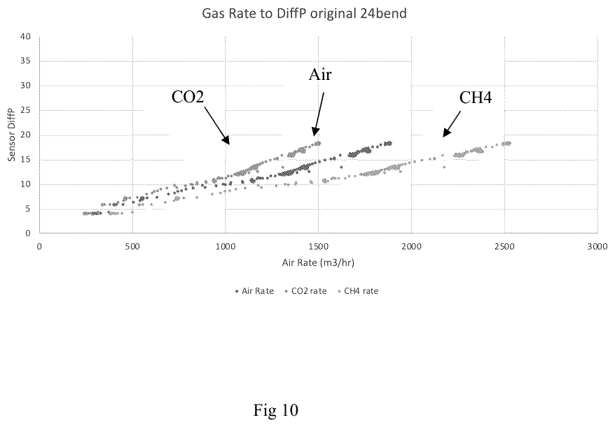

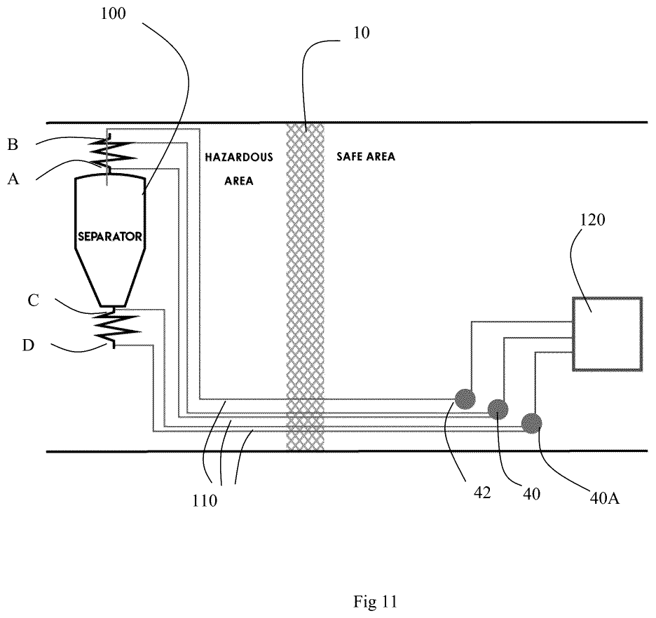

Referring to FIG. 10, a plot is shown which was obtained during calibration of a prototype of the embodiment of FIG. 1. Various gases were passed through the conduit 30 at known flow rates and the pressure drop at the differential sensor was noted. This data can be used as a basis to infer a flow rate of particular types of gas in use by measuring the pressure drop.

Another pressure sensor (42) is mounted on bracket (50) and is attached to a three-way valve (60). Pressure sensor (42) may be an Emerson 3051 wireless sensor similar to the one shown in FIG. 9. In a normal mode selection, the three-way valve puts the pressure sensor (42) into fluid communication with a pipe (not shown) which opens to the inside of the separation chamber (14) to measure the pressure in the chamber. The three-way valve (60) can be put into a second mode where the pressure sensor (42) is put into communication with a second external pipe (not shown) which is external of the separation chamber and terminates in a quick connect male fitting to enable measurement of the pressure of other sources as may be required in the field including but not limited to well shut in/build up pressure and cuttings sample cannister build up pressure.

The first convoluted conduit (30) and the two pressure measurement sensors (40, 42) which are mounted thereto are protected from the elements or accidental damage by way of a removable cylindrical housing depicted as comprising two like halves (43, 44) which in use are joined side by side to each other in a vertical plane, with one of the halves (43) defining a rectangular inspection window (46), through which the three-way valve 60 may be accessed. The inspection window is ordinarily covered by an inspection cover.

As best seen in FIG. 4, a second lower outlet of the separator (10) comprises a second conduit (30A) which carries liquid and solid underflow from the open lower end (21) of the separator. Conduit (30A) is in the form of a stacked spiral coil of metal pipe. Each straight length of pipe (32A) is joined to the next by a 90 angle-degree pipe bend (34A), and the stacked pipe coil shown comprises a total of 12 of these pipe bends (34A). Typically, the pipes themselves comprise <80 mm ID steel liquid flow lines, which cause a pressure drop of approximately 2.1 kPa at a flowrate of solid-liquid slurry material of up to around 300 litres/minute.

In further embodiments, a different shape and configuration of a stacked spiral coil of pipes can be interchanged with the one shown in the drawings, and, in addition, the diameter of the pipes can be altered, for example, to achieve a greater flowrate of the solid-liquid mixture of materials exiting the cyclonic separator (10) in an underflow discharge.

The second convoluted conduit in the form of the stacked pipe coil (30A) shown in the drawings is located below the cyclonic separator (10), with the pipework arranged with an alignment so that settled solids are fully flushed from the pipework with the assistance of sediment gravity traction flow. The conduit terminates at opening (38A) which protrudes laterally from the lower end of the spiral coil (30A), via which solid-liquid mixture material is passed to a further process stage (not shown).

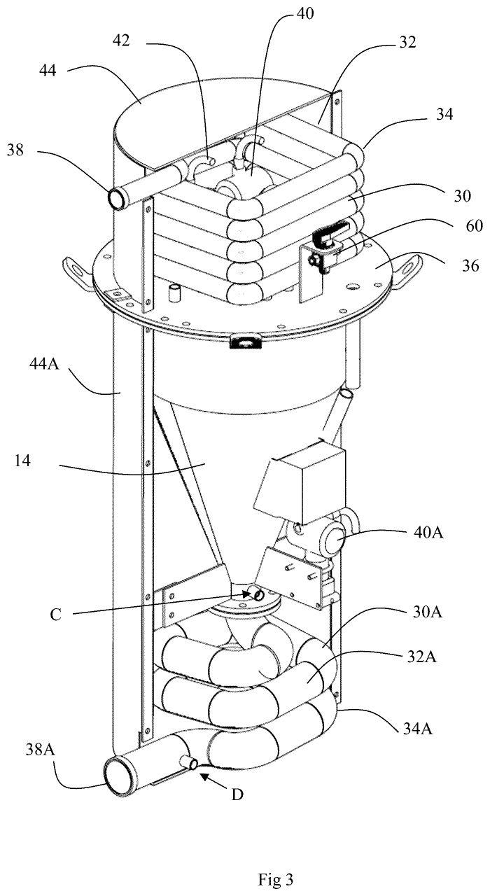

A pressure measurement arrangement in the form of a differential pressure sensor (40A) is associated with the conduit (30A) and is plumbed to the conduit (30A) by smaller diameter pressure hoses (not shown) at two spaced-apart positions along the conduit by being attached to apertures in the conduit at locations (C) and (D) as best seen in FIG. 3.

Location (C) is located on the conduit (30A) near to the position where the convoluted conduit (30A) is joined to the lower outlet (21) of the separation chamber (14). Location (D) is located on the conduit (30A) at a location near to outlet opening (38A) of the conduit (30A). As for the first conduit, the output of the differential pressure sensor (40A) can be calibrated to deduce the flow rate of material flowing through the conduit (30A). Detailed examination of the differential pressure signal generated across the lower fluid/solid coil enables solids loading to be deduced and rate of solids flow estimated.

The second convoluted conduit (30A) and the pressure measurement sensors (40A) which are mounted thereto are protected from the elements or accidental damage by way of a removable cylindrical housing depicted as comprising two like halves (43A, 44A) which in use are joined side-by-side to each other in a vertical plane, with one of the halves (43A) defining a rectangular viewing port or window (46A), through which pressure measurement instrumentation can be observed.

In other embodiments a colour sensor may be associated with the conduit (30A) to detect the colour of the material flowing through the lower conduit which enables additional operational data to be gathered relating to the exploration of excavation activity which is currently being undertaken.

The apparatus (10) enables measurement of the flowrate of material passing out of both of the upper and lower outlets of the separator. This is achieved with no sensing equipment extending into or otherwise obstructing the flow of material. Wireless sensors may be used to omit the need for direct electrical connections to the separator and diminish any spark risk posed in measuring the rates of flow and simplify device relocation.

Referring to FIG. 10, an alternative embodiment of separation apparatus (100) is shown. Unless otherwise indicated, this embodiment is otherwise as described in relation to apparatus (10) above and like parts will be identified using like reference numerals.

Apparatus (100) is located in a hazardous area where electrical sparks may pose a risk of detonation of flammable gasses. In this embodiment the pressure sensors (40), (40A) and (42) are not mounted in the same housing as the separation chamber and the conduits (30, 30A). Instead, static pressure lines in the form of pressure hoses (110) are used to remotely connect the pressure sensors to the locations on the conduits (A, B, C and D) to enable measurement of the pressures at those locations. The sensors (40, 40A and 42) along with a control system 120 are located in a safe area where there is no detonation risk. The hoses (110) pass through a wall or barrier (110) which separates the hazardous area from the safe area.

In the embodiment (100), absolutely no electrical devices associated with the separator are located in the hazardous area to further reduce the risk of any spark being generated in the hazardous area during operation.

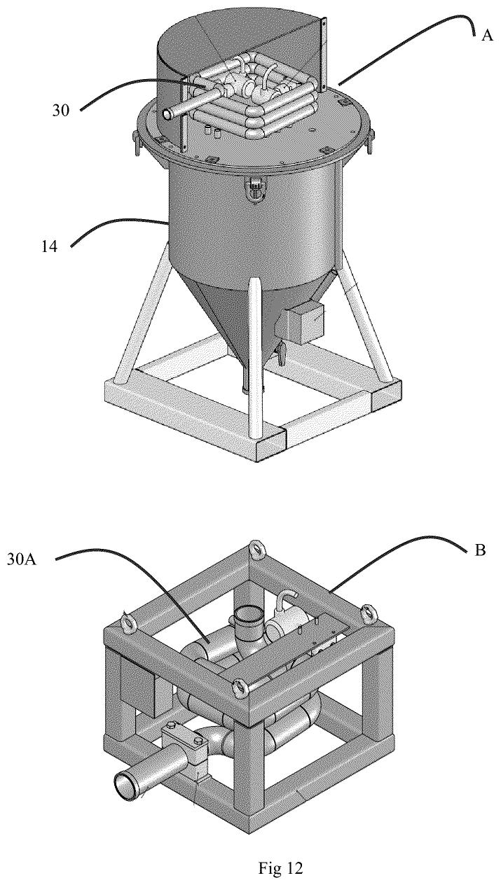

Referring to FIG. 12, an alternative embodiment of apparatus is shown which is arranged to be installed at a location so that the lower conduit is spaced away from the separator. In the embodiment of FIG. 12 the first conduit 30 and the separation chamber 14 are provided in an assembly A. The second conduit 30A is mounted in a separate frame as assembly B. Assembly B is intended to be installed in a position where it is This embodiment is useful for when gas rates are high or backpressure on the separator from the exhaust line is high, the liquid level could otherwise get pushed below the sensors in the second conduit-such that they lose the liquid rate signal.

Embodiments of the invention have at least one of the following advantages:
Measurement of flow rate is achieved without introducing any internal restrictions into the fluid flowpath
An arrangement can be provided which does not require use of any electrical sensors at all in a hazardous zone.
Apparatus is rugged enough to achieve a long service life to survive transportation and impacts in an underground coal mines
Provides enhanced information relating to operating condition to enable modern engineers and geologists to improve mine performance.

In this specification, when the term “convoluted” is used in reference to the outlet conduits of the separation chamber, it includes within its scope arrangement of conduit, usually in an arrangement which makes economical use of the available area adjacent to the separation chamber. For example, in relation to one another the conduits can comprise overlapping or stacked lengths of pipe, each of which are joined by pipe bends which subtend various different angles, so as to form an intricately folded, twisted, or coiled conduit or labyrinthine structure.

In the foregoing description of certain embodiments, specific terminology has been resorted to for the sake of clarity. However, the disclosure is not intended to be limited to the specific terms so selected, and it is to be understood that each specific term includes other technical equivalents which operate in a similar manner to accomplish a similar technical purpose. Terms such as “upper” and “lower”, “above” and “below” and the like are used as words of convenience to provide reference points and are not to be construed as limiting terms.

In this specification, the word “comprising” is to be understood in its “open” sense, that is, in the sense of “including”, and thus not limited to its “closed” sense, that is the sense of “consisting only of”. A corresponding meaning is to be attributed to the corresponding words “comprise”, “comprised” and “comprises” where they appear.

The preceding description is provided in relation to several embodiments which may share common characteristics and features. It is to be understood that one or more features of any one embodiment may be combinable with one or more features of the other embodiments. In addition, any single feature or combination of features in any of the embodiments may constitute additional embodiments.

In addition, the foregoing describes only some embodiments of the inventions, and alterations, modifications, additions and/or changes can be made thereto without departing from the scope and spirit of the disclosed embodiments, the embodiments being illustrative and not restrictive.

We claim:

1. An apparatus for separating a gaseous phase from a multiphase feed material of solids, liquids and gases, the apparatus comprising:
a separation chamber arranged to receive a flow of the multiphase feed material thereinto via an inlet;
a first outlet conduit, arranged in use to convey an exit flow of gaseous material which becomes separated from the multiphase feed material when in the separation chamber; and
a second outlet conduit, arranged in use to convey an exit flow of the remainder of the multiphase feed material following separation of the gaseous material;
a differential pressure measurement arrangement is associated with the first outlet conduit and is arranged to measure a difference between the pressures of the gaseous material inside the conduit at two spaced-apart locations along the conduit, to thereby enable a measurement of a flowrate of the gaseous material through the conduit.

2. The apparatus according to claim 1, wherein the differential pressure measurement arrangement incudes a differential pressure sensor.

3. The apparatus according to claim 2, wherein a pressure measurement arrangement is also associated with the second outlet conduit and is arranged to measure the pressure of the material inside the conduit at two spaced-apart positions along the conduit, to thereby enable a measurement of the flowrate of the material through the conduit.

4. The apparatus according to claim 1, wherein a pressure measurement arrangement is also associated with the second outlet conduit and is arranged to measure the pressure of the material inside the conduit at two spaced-apart positions along the conduit, to thereby enable a measurement of the flowrate of the material through the conduit.

5. The apparatus according to claim 1, wherein the separator includes a further pressure measurement device which is arranged to measure the pressure of material inside the separation chamber.

6. The apparatus according to claim 1, wherein the separation chamber comprises a cyclonic separator having a central axis, and which further comprises:
that the inlet for delivering the flow of feed material is arranged in a lateral direction to the central axis;
the separation chamber is of a generally conical internal shape extending in the direction of the central axis, with a decreasing distance between its internal side wall and the central axis when moving away from the inlet;
the first outlet has an overflow discharge located at an upper in use end wall coaxial with the central axis; and region; and
the second outlet is an underflow discharge arranged at a lower in use end region coaxial with the central axis.

7. The apparatus according to claim 1, wherein at least one of the outlet conduits is arranged in a convoluted configuration.

8. The apparatus according to claim 7, wherein said at least one conduit comprises a plurality of straight pipe sections which are interspersed with angled pipe sections.

9. The apparatus according to claim 8, wherein said angled pipe sections subtend a 90-degree angle bend.

10. The apparatus according to claim 9, wherein said pipe sections comprising each respective outlet conduit are of substantially equal internal bore diameter.

11. The apparatus according to claim 8, wherein said pipe sections comprising each respective outlet conduit are of substantially equal internal bore diameter.

12. The apparatus according to claim 1, wherein the second outlet conduit is spaced away from the separator.
